(19) United States
(12) Patent Application Publication
(10) Pub. No.: US 2023/0058770 A1
(43) Pub. Date: Feb. 23, 2023

(54) INSIGHT CAPTURING ENGINE IN A DATA ANALYTICS SYSTEM

(71) Applicant: The Boston Consulting Group, Inc., Boston, MA (US)

(72) Inventors: Daniel Aaron Sack, Stockholm (SE); Olivier Roger Ali Kahn, Paris (FR); Antti Olavi Niskanen, Espoo, FL (US); Slobodan Milovanovic, Siqtuna (SE); Sean Ariel, Saint-Gilles (BE)

(21) Appl. No.: 17/591,105

(22) Filed: Feb. 2, 2022

Related U.S. Application Data
(60) Provisional application No. 63/235,052, filed on Aug. 19, 2021.

(51) Int. Cl. G06Q 30/02; G06N 20/00; G06Q 30/06; G06K 9/62

(52) U.S. Cl. CPC G06Q 30/0202; G06N 20/00; G06Q 30/0201; G06Q 30/0631; G06K 9/6262; G06K 9/6256

(57) ABSTRACT

Methods, systems, and computer storage media for providing an insight capturing interface of an insight capturing engine in a data analytics system. The insight capturing interface refers to an interaction mechanism for capturing and aggregating answers from users. The responses are used to generate, identify, derive insights (e.g., relationship information) that correspond to features (e.g., user features, product features) associated with the responses. The insight capturing interface operates with the insight capturing engine to sequentially generate a combination of interface elements for retrieving the responses. In particular, the insight capturing engine operates to provide a survey (e.g., a perpetual survey) in which users continuously prompted with a pair of products to capture their insights, where the insights support generating inference models. For example, the survey can ask them to select one out of two offered products that has a greater commercial potential or attractiveness and rank them against each other.

### CROSS-REFERENCE SECTION

The present application claims the benefit of U.S. Provisional Application No. 63/235,052, filed Aug. 19, 2021 and entitled “INSIGHT CAPTURING ENGINE IN A DATA ANALYTICS SYSTEM”, the entirety of which is incorporated by reference herein.

### BACKGROUND

Many companies rely on data analytics systems to support discovering useful information, informing conclusions, and decision-making based on data. Data analytics systems can support forecasting—such as a forecasting system—that uses historical data as inputs to predict future trends. Forecasting systems can also be used for projecting demands for goods and services offered. Machine learning techniques implemented in forecasting systems allow for improved forecasting system operations including accelerating data processing speed, providing a more accurate forecast, automating forecasting updates based on recent data, analyzing more data, identifying hidden patterns in data, creating a more robust system, and increasing adaptability to changes. For example, when forecasting demand during a planning process, inference models can be employed to analyze available data that can be used to predict future outcomes.

Conventionally, data analytics systems are not equipped with a computing infrastructure and logic to systematically capture and operationalize commercial insights that support machine learning techniques. In particular, conventional forecasting systems in data analytics systems do not quantify intuitive personal skill levels or upskill potential in association with machine learning models. For example, forecasting systems may have insufficient data, non-representative data, poor quality data which limits the capacity to train machine learning models to provide accurate predictions. Moreover, forecasting systems operate based on traditional interfaces and data sources for accessing training data and lack a user interaction model that seamlessly integrates smart capture and analysis of relevant training data. As such, a more comprehensive data analytics systems—having an alternative basis for providing data analytics systems operations—can improve computing operations and interfaces in data analytics systems.

### SUMMARY

Various aspects of the technology described herein are generally directed to systems, methods, and computer storage media, for among other things, providing insight capturing interface of an insight capturing engine in a data analytics system. The insight capturing interface refers to an interaction mechanism for capturing and aggregating responses (e.g., answers to prompts) from users. The responses are used to generate, identify, and derive insights (e.g., relationship information) that correspond to items (e.g., products) associated with the responses. The insight capturing interface operates with the insight capturing engine to sequentially generate a combination of interface elements (e.g., insight capturing engine interface elements associated with product pairs) for retrieving the responses. In particular, the insight capturing engine operates to provide a survey (e.g., a perpetual survey) in which users (e.g., experts for a product) are continuously prompted with a pair of products to capture their insights, where the insights support generating inference models. For example, the survey may prompt users to select one out of two offered products that has a greater commercial potential or attractiveness and rank them against each other. Product pairs can be provided differently depending on corresponding goals of the survey (e.g., prioritizing sorting of the top of the product rank list or prioritizing sorting of the entire list of products).

In operation, the captured insight data (i.e., answers and other contextual data) can be saved in a transactional form as raw information. The captured insight data can then be processed to generate user scores, product scores and identify insights on expert skills and upskilling proposals (i.e., determining new and different skills to train employees on). The captured insight data can further be used to generate forecasting machine learning training data (e.g., training data comprising user scores, product scores, item features) that are then used to train forecasting machine learning models (e.g., inference models that embedded with the forecasting machine learning training data). The forecasting machine learning models—generated based on the captured insight data—can be employed for predictive analysis.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary data analytics system with an insight capturing engine and a forecasting engine, in which embodiments described herein may be employed;

FIGS. 1C-1H are schematic representations of interfaces of a data analytics system with an insight capturing engine and a forecasting engine, in which embodiments described herein may be employed;

FIGS. 2A and 2B are block diagrams of an exemplary data analytics system with an insight capturing engine and a forecasting engine, in which embodiments described herein may be employed;

FIG. 3 is a flow diagram showing an exemplary method for implementing a data analytics system with an insight capturing engine and a forecasting engine, in accordance with embodiments described herein;

FIG. 4 is a flow diagram showing an exemplary method for implementing a data analytics system with an insight capturing engine and a forecasting engine, in accordance with embodiments described herein;

FIG. 5 is a flow diagram showing an exemplary method for implementing a data analytics system with an insight capturing engine and a forecasting engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

### Overview

By way of background, data analytics systems can support forecasting—such as a forecasting system—that uses historical data as inputs to predict future trends. Forecasting systems can be used for projecting demands for goods and services offered. Demand forecasting systems in combination with machine learning techniques can help forecasting future sales or other product predictions. Demand forecasting can include predicting demand for products such that manufactures can decide what products should be produced. Demand forecasting can improve different aspects of commerce from marketing campaigns to manufacturing management. Demand forecasting can include quantitative forecasting methods (e.g., regression analysis, adaptive and exponential smoothing) and qualitative forecasting methods (e.g., focus groups, historical analogy, and expert opinions).

Machine learning approaches to demand forecasting further allow learning from data and improving analysis. Operationally, developing a machine learning model for forecasting can be performed via a machine learning engine that supports gathering training data, defining goals and metrics associated with training data features or attributes (e.g., product features, time features etc.) Machine learning techniques can include Long Short-Term Memory (LSTM), Random Forest, and Linear Regression to develop forecasting models. For example, a linear regression approach can help predict future values from past values based on identifying underlying trends, so using historical data, additional information about the specific product, discounts, and average market cost, a prediction of a future value can be provided as a recommendation. The machine learning engine can further support training the forecasting models (i.e., using historical data and algorithms), validation (i.e., optimizing forecasting model parameters and hyper-parameters), and deployment (e.g., integration into production use).

By way of illustration, when forecasting demand during a planning process, inference models can be employed to analyze available data that can be used to predict future outcomes. For example, planning product demand can be part of a supply chain management process of forecasting or predicting demand for products to ensure they can be delivered and satisfy customers. The goal is to strike a balance between having sufficient inventory levels to meet customer needs without having a surplus. In some situations, a new product may be introduced into a business line, as such, historical data exists (e.g., past performance) for the demand for the product. In a scenario with new products, conventional forecasting techniques (e.g., machine learning models and time series data) are not available to make predictions on the demand of the new products. One way of addressing this problem is to look at similar products and past knowledge of similar products including implementing product master data systems. Product master data systems can refer to a system by which organizations organize and store information about all the key attributes (e.g., color, weight of fabrics, and other similar attributes to other products). While this additional data can be useful, even slightly more data can significant in improving forecast accuracy.

Conventionally, data analytics systems are not equipped with a computing infrastructure and logic to systematically capture and operationalize commercial insights that support machine learning techniques. For example, a data analytics system can include a forecasting system for projecting demands for goods and services offered. Forecasting systems may have insufficient data, non-representative data, poor quality data which limits the capacity to train machine learning models to provide accurate predictions. Forecasting systems operate based on traditional interfaces and data sources for accessing training data and lack a user interaction model that seamlessly integrates smart capture and analysis of relevant training data. At best, conventional data gathering for product planning may involve manually incorporating additional data into a forecasting engine to improve machine learning models that support making forecasting predictions. However, these manual processes can be cumbersome and tedious and lacking automated processing and integration with the data analytics system as a whole.

Moreover, conventional forecasting systems cannot quantify personnel skill level or upskill potential (e.g., new and relevant competencies). For example, a planning expert can have insights into a particular project or process; however forecasting systems lack a mechanism for capturing and quantifying this information in order to incorporate this information into forecasting system operations. Capturing the commercial insight and making the captured information usable in a forecasting system is missing in conventional forecasting systems, with such forecasting systems developed and implemented exclusively based on traditional data sources. As such, a more comprehensive data analytics systems—having an alternative basis for providing data analytics systems operations—can improve computing operations and interfaces in data analytics systems.

Embodiments of the present disclosure are directed to providing an insight capturing interface of an insight capturing engine in a data analytics system. The insight capturing interface refers to an interaction mechanism for capturing and aggregating responses (e.g., answers to prompts) from users. The responses are used to generate, identify, and derive insights (e.g., relationship information) that correspond to items (e.g., users and products) associated with the responses. The insight capturing interface operates with the insight capturing engine to sequentially generate a combination of interface elements (e.g., insight capturing engine interface elements associated with product pairs and product master data) for retrieving the responses. In particular, the insight capturing engine operates to provide a survey (e.g., a perpetual survey) in which users (e.g., experts for a product) are continuously prompted with a pair of products to capture their insights, where the insights support generating inference models. For example, the survey may prompt users to select one out of two offered products that has a greater commercial potential or attractiveness and rank them against each other. Product pairs can be provided differently depending on corresponding goals of the survey (e.g., prioritizing sorting of the top of the product rank list or prioritizing sorting of the entire list of products).

In operation, the captured insight data (i.e., answers and other contextual data) can be saved in a transactional form as raw information. The captured insight data can then be processed to generate user scores, product scores and identify insights on expert skills and upskilling proposals (i.e., determining new and different skills to train employees on). The captured insight data can further be used to generate forecasting machine learning training data (e.g., training data comprising user scores, product scores, item features) that are then used to train forecasting machine learning models (e.g., inference models that embedded with the forecasting machine learning training data). The forecasting machine learning models—generated based on the captured insight data—can be employed for predictive analysis via the forecasting engine. As such, the insight capturing engine is provided for addressing demand forecasting. Demand forecasting can be facilitated based on capturing personal commercial insight and quantifying skill level and upskilling potential using insight data from users (e.g., experts associated with certain products of an organization).

In one implementation, the insight capturing engine includes pair drawing, product scoring, ranking (products and users), skill analysis and updating. Pair drawing can include algorithms or procedures for serving product pairs during a survey. Product pairs can be served differently depending on goals associated with a survey. For example, a product pair can be identified for comparing similar attributes of a product, or a product pair may be identified to based previously received responses from a user. Moreover, product scoring can include algorithms or procedures on how to update the product score based on the survey outcome. For example, a first product that is selected in a survey—over a second product—receives an increased ranking score while the second product receives a decreased ranking score. Scoring increments and decrements may be weighted by an expert skill level. The insight capturing engine can also be implemented as a ranking tool. The score can be used to generate a ranked list of users and products associated with a survey. The insight capturing engine can generate scores for the captured insight data such that the scores are used as raw input data or training data for a forecasting engine and producing demand forecast. In this way, a forecasting system and forecasted outcomes can be improved compared to forecasting system without captured insight data.

Moreover, the skill update and upskilling analysis of the insight capturing engine includes algorithms or procedures that quantify the user (i.e., expert) skills level based on survey performance. The skill level is updated based on backtesting data in the survey, where aggregate data about survey pairs converge on a particular outcome. Backtesting involves applying a predictive model to historical data to determine the accuracy of the data. In this way, backtesting includes methods for determining how well a strategy or model would have done ex-post or assesses the viability of a strategy by discovering how it would play out using historical data. If backtesting works or fails, the insight capturing engine can employ the success data or failure data to update the skill levels of corresponding users. Additionally, the skill level can be incremented and decremented dependent on a difficult level associated with each question in the survey, and based on a product score distance.

Upskilling analysis is based on identifying or clustering a group of products for which a user has performed poorly or extremely well on, and performing cluster analysis to identify outlier experts that perform survey differently than common clusters. For example, the upskill analyzer can be used to perform clustering operations on the responses to find latent relationships in the captured insight data. The product scores and user scores—associated with user skills data—are then used as features in training forecasting machine learning models for predicting the demand for ranked products. It is contemplated that the insight capturing engine can operate independently of a forecasting system (including a planning system); however the inference models from the captured insight data can boost analysis traditionally performed via the forecasting system.

Operationally, the insight capturing engine can be built on a gamification framework, where the gamification framework provides interfaces, tools, and a library that include gaming techniques to motivate participation and long-term engagement from users. The gamification framework can include game-design interface elements and game principles (dynamics and mechanics) in an insight capturing process for products associated with demand planning. The gamification framework of the insight capturing engine can be configured to capture insights that may not be easily captured using traditional demand planning methods. For example, text associated with a product (e.g., text on packaging) may have a certain impact on a particular market—an insight that is not universally shared among experts associated with the product, or available in the product master data. In another example, an expert who understands that an upcoming trend for the next fashion season will drastically change normally has no automated or systematic way to communicate this information such that the information is adequately incorporated into a data analytics system. However, with the insight capturing engine, such insights can be captured and applied to other aspects of data analytics. Convergence models and data analytics can be used to cluster users, questions, answers, and score to derive additional insights. For example, as iterations questions are provided to users, the responses (e.g., for all users or for a subset of users) can get closer and closer to some specific value.

The insight capturing engine—via a perpetual survey—can provide a means for collecting expert insights independently of a planning process. The conventional forecasting data can also be complemented by commercial insights of experts. For example, experts commonly possess additional intuition that is not systematically captured in traditional forecasting data. Depending on the skill levels associated with an expert, the commercial insight could pose significant information gain for inference models, thus improving the predictive power of the inference model. An expert can access a survey through an application on a client device and answer constructed questions about two or more products at a time—without the distraction of a line of products. The aggregated captured insight data can be stored and transformed into variations of machine learning data that can be used to improve a forecasting system. In this way, the insight capturing engine is part of an end-to-end data analytics system that uses systematically captured insight data—to produce demand forecast training data for developing inference models—for demand forecasting associated with products or product families presented via a survey.

Crowdsource rating-ranking algorithms and models can be used to determine products (e.g., pair of products) to present in different questions. In one implementation, a set of priors (e.g., user scores indicating ranking)—that defines distributions of users—can be configured. A pre-sorted list of products can also be initially provided. The insight capture engine, as discussed, operates to increase information gain for each product and user, as such, questions are selected to increase the information gain. Different algorithms can be implemented for selecting pairs in order to achieve the goal of increasing information gain. For example, pairwise comparison questions can be generate based on the features (e.g., attributes) of the products being compared. The questions can be associated with a scale for rating preferences with respect to a pair of products and a corresponding criteria. The questions can be designed to include pairs of products that are presented to users. The pairs of products that are presented to a particular user can be based on the types of questions and answers previously presented to a particular user. The questions (and pairs of products associated with the questions) could also be based on answers provided by other users. The questions are not static, but rather are dynamically selected and presented to derive certain insights. For example, product pairs in a product ranking interface can be generated based on pairing algorithms for serving product pairs during a survey. Other variations and combinations of crowdsource rating-ranking algorithms and pairwise ranking aggregation are contemplated with embodiments described herein.

Product pairs can be served differently depending on the goal of the product pairs. For example, a goal for a particular survey can be to prioritize sorting a top portion of a product ranking list or prioritize sorting an entire product ranking list. In this way, the insight capture engine can include user profiles that include attributes (e.g., question and answer data for particular users) that are used in generating questions for the insight capturing engine interface. An insight capturing engine machine learning algorithms can be used to analyze the responses to identify patterns in the responses and make certain inferences. In this way, the insight capturing engine interface and insight capture engine machine learning algorithms can support efficient collection of embedded knowledge and relative performance between a plurality of users. Moreover, the insight capturing engine can include a user training feedback engine that includes insights that educate different users on their responses and the responses of other users.

By way of example, the insight capturing engine may pose a question asking whether product A will outperform product B. A user (e.g., client teams, experts, designers, sellers, anyone who can broaden the base of institutional knowledge)—running the insight capturing engine client on a device—can answer the question. The insight capturing engine can provide additional questions for different combinations and permutations of products. The insight capturing engine can the take the responses to the questions and create a ranking as well as score products, simultaneously as a plurality of users are responding to the different questions. The responses, scores, and ranks can be used along with historical information associated with existing products to support a forecasting engine. Advantageously, the responses, ranks, and score improve the forecast accuracy of a forecasting engine, if it had otherwise operated without the insight capturing engine. The insight capturing engine can deployed as a mobile application as part of a data analytics system and forecasting and planning ecosystem with captured insight data—associated with different types of users—as input to influence forecasts.

The insight capturing engine can generate scores associated captured insight data products. The insight capturing engine ranking output can be used to support backtesting performance of response sets associated with a user. Backtesting is used in modeling and can refer to testing a predictive model on historical data. Backtesting supports cross-validation applied to the previous time periods—or in this case previous response sets of users. In this way, user scores can be associated with a particular user, where the user score quantifies how good the user is at ranking products. For example, the user score can be used to indicate how much the user understands the commercial attractive or commercial appeal of different products. The user score can be used to weight up or down the user's input in the forecasting engine. The user score can also be used to inform and train user on where they are better or worse at ranking. A leaderboard can be available to quickly provide a ranking of users.

The insight capturing engine provides different types of interfaces that include interface elements that support systematically gathering insight data. For example, a product ranking interface, a product score interface, a user score interface, and a skill update interface with upskilling analysis. The insight capturing engine supports statistically rigorous computation that is associated with a gamification experience (via an insight capturing engine interface). The insight capturing engine interface provide a question and a response interface (e.g., swipe left and swipe right). The insight capturing engine interface along with the frequency of questions posed to a user allows capturing a significant amount of data that can be analyzed systematically to remove biases. For example, with the frequency and repetition is possible to identify conflicting information and can be statistically analyzed—for the user and the plurality users—and removed.

The insight capturing engine operates as a component of the data analytics engine where the data from the insight capturing engine is provided as input to a forecasting engine. The forecasting engine includes a forecasting algorithm that is designed to process the user score and product score to generate demand recommendations for products. The forecasting engine can also support backtesting based on historical data, where data from the insight capturing engine can be compared to current demand recommendation or past demand recommendations to provide feedback into the insight capture engine scoring and ranking. In one implementation, the insight capturing engine can include products that already exist with new products. The data from the existing products can be used to calibrate the operations for both the insight capturing engine and forecasting engine, as historical data is available for existing products. Several different approaches can be used for incorporating the insight data into the forecasting engine. For example, only ranking data can be incorporated, performance ratings and product attributes can be used as features in the forecasting engine and training forecasting models. Other variations and combinations are contemplated with embodiments described herein.

The insight capturing engine can be configured to maximize information gain from a plurality of users. The insight capturing engine can include machine learning models that operate such that the amount of information gained about a random variable (e.g., question or question attribute) can be maximized by observing other questions and answers. The insight capturing engine performs different types of comparisons to make decisions on what subsequent questions and interface elements should be presented. The insight capturing engine determines what questions to show to a user next based on the machine learning model. For example, product scores and user scores can be generated such that the scores are used to identify questions for a particular user. User scores can quantify a skill level of a user relative to other users. The questions and response data can be stored in a transactional database. The transactional database stores different attributes of each individual question instance. Products and users get scores that are also stored and periodically updated based on additional data that is stored in the transactional database.

Generally, scoring can include increasing score when a user is right and decreasing a score when a user is wrong, especially relative to other users for new products. Moreover, for old products, the score can be associated with past performance, where a user score is increased or decreased based on past performance data associated with a product. Scoring can also be associated with specific attributes of products. For example, if the only difference between a first product and a second product is the color and a user can accurately identify the first product as a product that is more commercially attractive, then the score and the attribute are identified as features that further support the forecasting engine. User scores can also be provided to automatically make recommendation for planning teams for current or future planning projects. For example, the user scores can be an indication of how good a particular user is at understanding the commercial attractiveness of different products. As such, those types of users could be identified for planning teams.

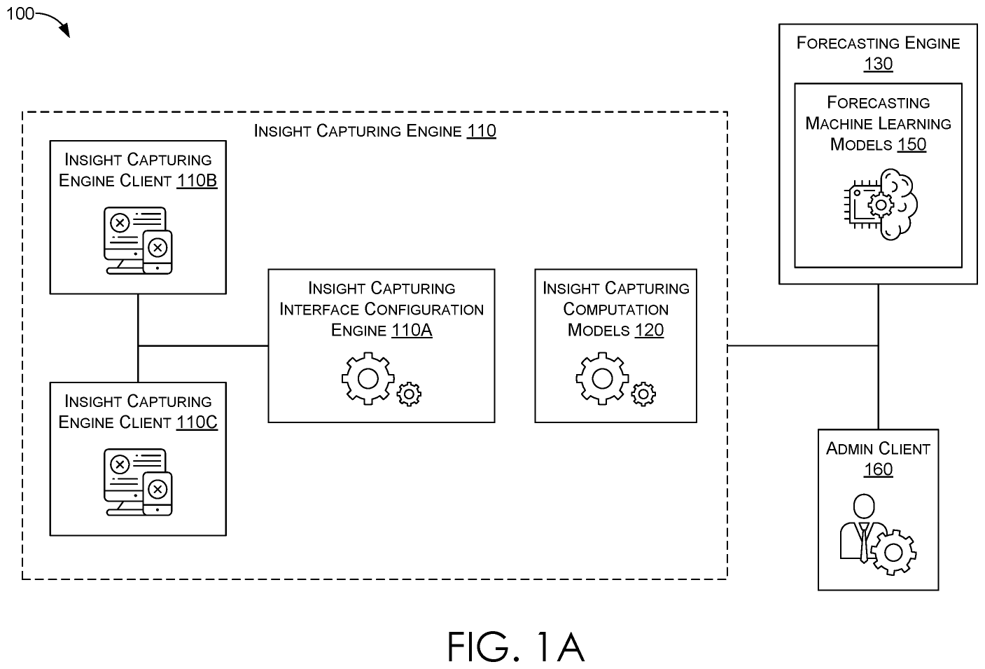

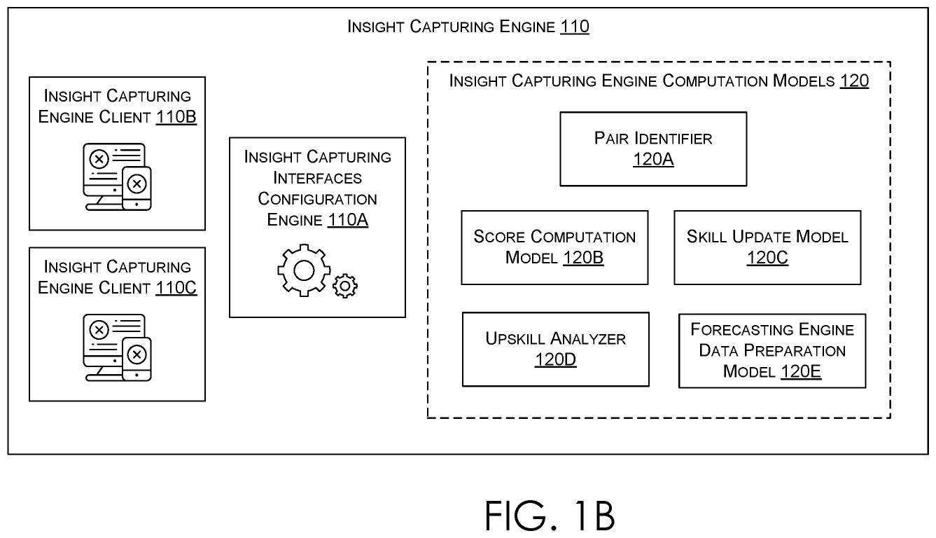

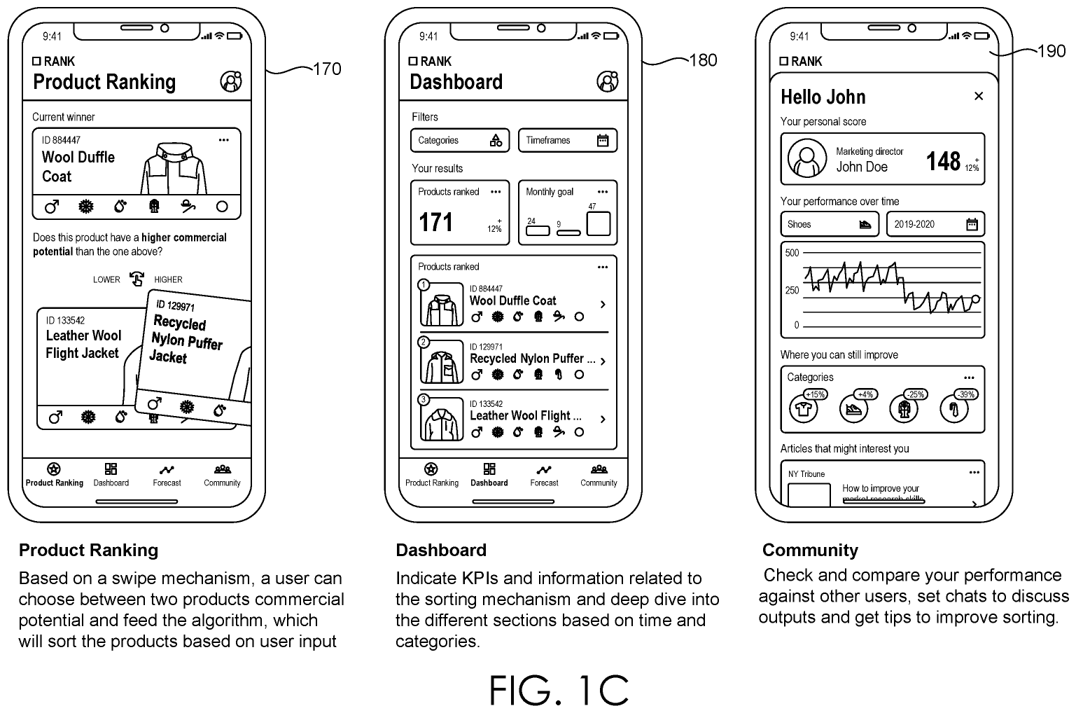

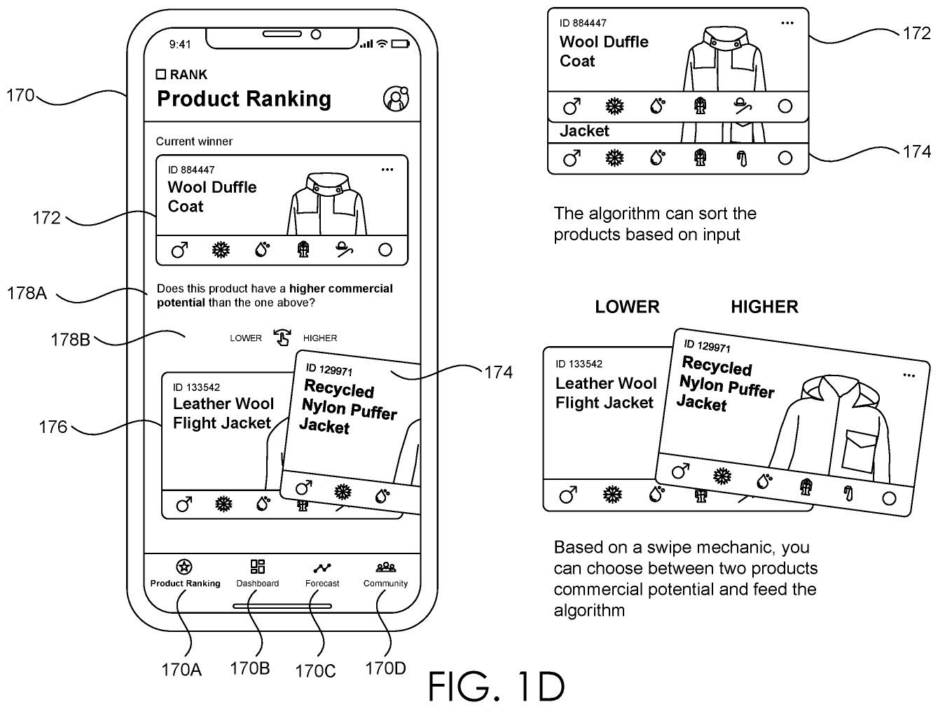

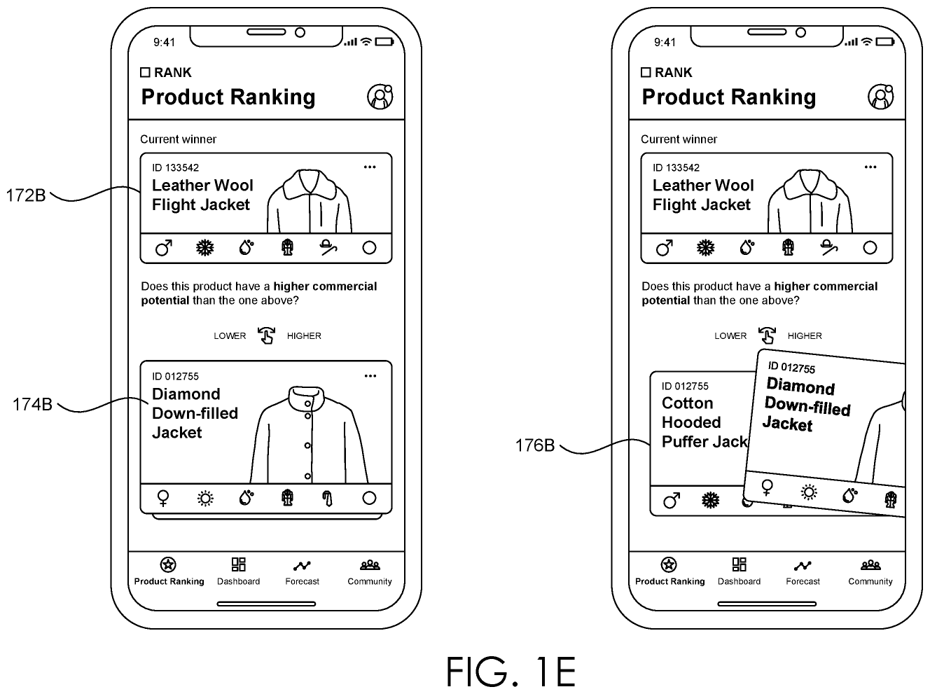

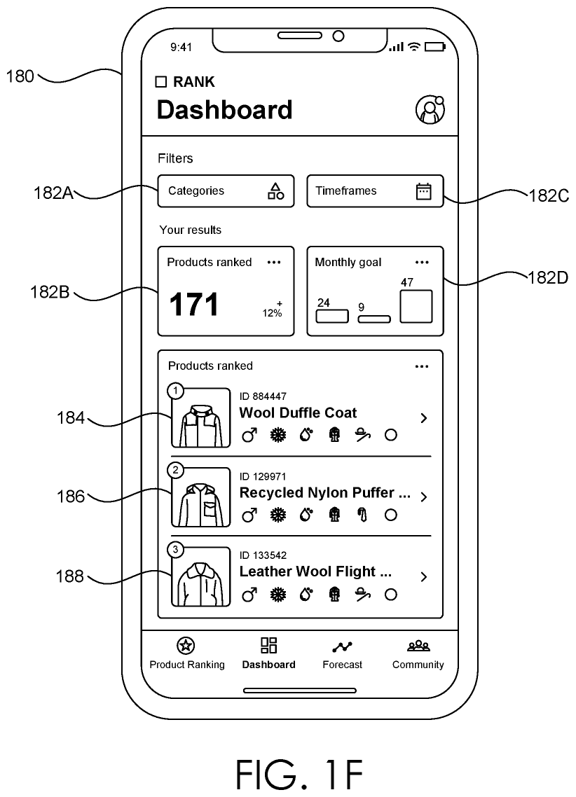

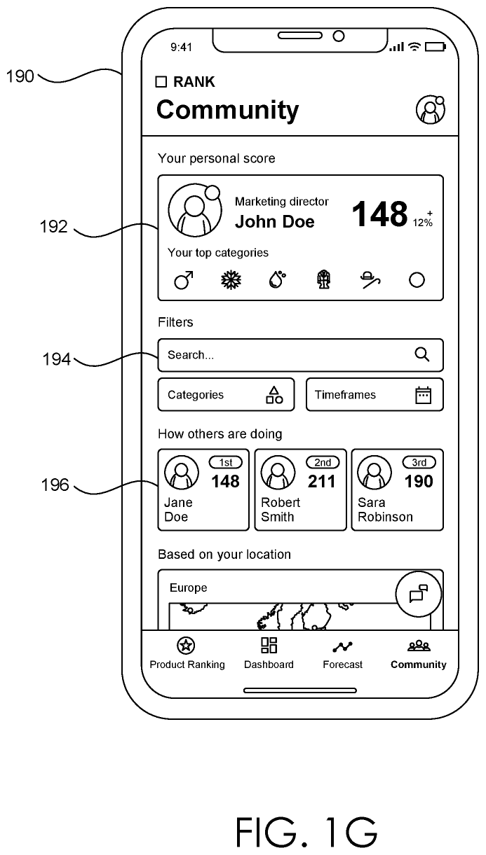

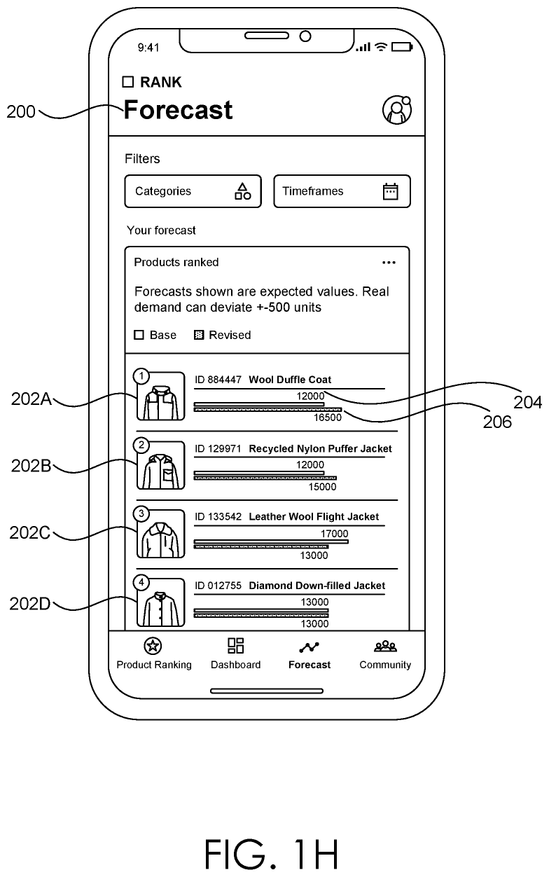

Aspects of the technical solution can be described by way of examples and with reference to FIGS. 1A, 1B, 1C, and 1D. FIG. 1A illustrates a data analytics system 100—including insight capturing interfaces configuration engine 110A, insight capturing engine client 110B, insight capturing engine client 110C, insight capturing computation models 120, forecasting engine 130 having forecasting machine learning models 150, and admin client 160.

The data analytics system 100 provides an operating environment for aggregating, transforming, processing, and modeling data with the goal of discovering useful information, informing conclusions, and support decision-making. The data analytics system 100 includes the insight capturing engine 110, the forecasting engine 130, and the admin client 160 that support hardware and software operations in the data analytics system 100. For example, insight capturing engine 110, the forecasting engine 130, and the admin client can support generating questions for collection of insight captured data, presenting interfaces for collecting the insight captured data from a plurality of user and processing the data to generate forecasting machine learning training data and training forecasting machine learning models for making forecasting recommendations.

The forecasting engine 130 and forecasting machine learning models 150 can support demand forecasting using machine learning techniques can help forecasting future sales or other product predictions. Demand forecasting can include predicting demand for products such that manufactures can decide what products should be produced. Demand forecasting can specifically be associated with a planning process and inference models that analyze available data to predict further outcomes. As discussed, the captured insight data can be used to generate forecasting machine learning training data (e.g., training data comprising user scores, product scores, item features) to improve the forecasting machine learning models and their corresponding predictions or recommendations. Other variations and combinations of data analytics systems and forecasting engines are contemplated with embodiment described herein.

With reference to FIG. 1B, FIG. 1B illustrates aspects of the insight capturing engine 110. FIG. 1B includes including insight capturing interfaces configuration engine 110A, insight capturing engine client 110B, insight capturing computation models 120 including pair identifier 120A, score computation model 120B, skip update model 120C, upskill analyzer 120D and forecasting engine data preparation model 120E. At a high level, the insight capturing engine supports collecting captured insight data (i.e., answers and other contextual data) that can be saved in a transactional form as raw information. The captured insight data can then be used or processed to generate user scores, product scores and identify insights on expert skills and upskilling proposals (i.e., determining new and different skills to train employees on). The captured insight data can further be used to generate forecasting machine learning training data (e.g., training data comprising user scores, product scores, item features) that are then used to train forecasting machine learning models (e.g., inference models that embedded with the forecasting machine learning training data). The forecasting machine learning models—generated based on the captured insight data—can be employed for predictive analysis.

In operation, insight capturing engine 110 captures and aggregates responses from users (e.g., via insight capturing engine client 110B). The insight capturing engine causes the insight capturing interface configuration engine 110A to generate insight capturing engine interface elements that are used to communicate questions (e.g., via a perpetual survey) to an insight capturing engine client. Responses (i.e., captured insight data) are received from the insight capturing engine client and used to generate, identify and derive insights that correspond to items associated with the questions and responses. Generating, identifying, and deriving insights can be based on different types of machine learning techniques that are applied to the captured insight data. The responses and insights can further be used to generate forecasting machine learning training data and forecasting machine learning models.

With reference to FIG. 1C, FIG. 1C illustrates aspects—insight capturing engine interface elements—of the insight capturing engine 110. FIG. 1C includes a product ranking interface 170, a dashboard interface 180, a community interface 190. The product ranking interface 170 can support a swipe mechanism, such that a user can respond to a query (e.g., choose between two products commercial potential) and feed an algorithm (e.g., a ranking algorithm for the products) which will sort the products based on the user input. The dashboard interface 180 can be used to retrieve and present key performance indicators (i.e., KPIs) and information related to sorting mechanics and additional data associated with user activity, products, and responses. The community interface 190 can provide an interface for checking and comparing a user's performance against other users, set chats to discuss outputs, and get tips to improve sorting.

With reference to FIG. 1D, FIG. 1D illustrates aspects—insight capturing engine interface elements—of the insight capturing engine 110. FIG. 1D includes a product ranking interface 170 having a plurality of insight capturing engine menu items (i.e., product ranking 170A, dashboard 170B, forecast 170C, and community 170D), a current winner product 172, a current product 174, a next product 176; a question prompt 178A, and responses to the prompt 178B. The insight capturing engine includes a plurality of insight capturing engine computation models 120. In particular, the pair identifier 120A can include algorithms or procedures for serving product pairs during a survey. Product pairs can be served differently depending on goals associated with a survey. Product scoring can include algorithms or procedures on how to update the product score based on the survey outcome. As shown, a current winner product 172 can be compared to current item 174, and next item 176. And based on the swipe associated with the responses to the prompt 180B a user can choose between two products.

With reference to FIG. 1E, FIG. 1E illustrates another example of a current winner product 172B, a current product 174, and a next product 176. The responses received can be used to generate a ranking (e.g., via score computation model 120B) for the products. For example, a first product that is selected in a survey—over a second product—receives an increased ranking score while the second product receives a decreased ranking score. Scoring increments and decrement may be weighted by an expert skill level. The insight capturing engine 110 can also be implemented as a ranking tool. The score can be used to generate a ranked list of users and products associated with a survey. The insight capturing engine can generate scores for the captured insight data such that the scores are used as raw input data or training data for producing demand forecast.

With reference to FIG. 1F, FIG. 1F illustrates aspects—insight capturing engine interface elements—of the insight capturing engine 110. FIG. 1F includes the dashboard interface 180 along with dashboard interface features (e.g., filters) associated with the user, products, responses etc. For example, dashboard interface features can include categories 182A, number of products ranked 182B, time frames 182C, and monthly goals 182D. Categories can refer to different categories of products, time frame can refer to a particular range time period for retrieving data, monthly goals can refer to an expected number of responses expected from a user. Products that are ranked can also be provided in ranked order (e.g., product 184, product 186, and product 188). Other variations and combinations of dashboard interface features associated with collecting and presenting KPIs for captured insight data are contemplated with embodiment described herein.

With reference to FIG. 1G, FIG. 1G illustrates aspects—insight capturing engine interface elements—of the insight capturing engine 110. FIG. 1G includes the community interface 190 along with community interface features associated with the user, products, and responses. For example, the community interface data can include user profile and results data 192, a search bar 194, and, comparative ranking data. In this way, a user can check and compare their performance against other user, set chats to discuss outputs and get tips on improving sorting. In particular, the skill update model 120C and the upskill analyzer 102D can be used to derive insights from the captured insight data. For example, the skill update model can be used to quantify a skill level of a user based on performance on the questions. The upskill analyzer can be used to identify a group of products for which a user has performed poorly or extremely well, and cluster analysis can be performed to identify outlier experts that perform survey differently than common clusters.

With reference to FIG. 1H, FIG. 1H illustrates aspects—insight capturing engine interface elements—of the insight capturing engine 110. FIG. 1H includes the forecast interface 200 along with recommendations or predictions associated with a forecasting engine (e.g., forecasting engine 130). For example, the forecast interface can include a plurality products (e.g., product 202A, product 202B, and product 202C, and product 202D) having corresponding forecast recommendations (e.g., forecast recommendation 206) associated with a base recommendation (e.g., base recommendation 204). The forecasting engine can operate to make predictions for demand for a product. The base recommendation 204 can be associated with the forecasting engine and forecasting machine learning model not trained on the captured insight data, while the forecast recommendation 206 can be associated with the forecasting engine and forecasting machine learning models trained on captured insight data.

As discussed, the conventional forecasting data can also be complemented by commercial insights of experts. For example, experts commonly possess additional intuition that is not systematically captured in traditional forecasting data. Depending on the skill levels associated with an expert, the commercial insight could pose significant information gain for inference models, thus improving the predictive power of the inference model. An expert can access a survey through an application on a client device and answer constructed questions about two or more products at a time—without the distraction of a line of products. The aggregated captured insight data can be stored and transformed into variations of machine learning data that can be used to improve a forecasting system.

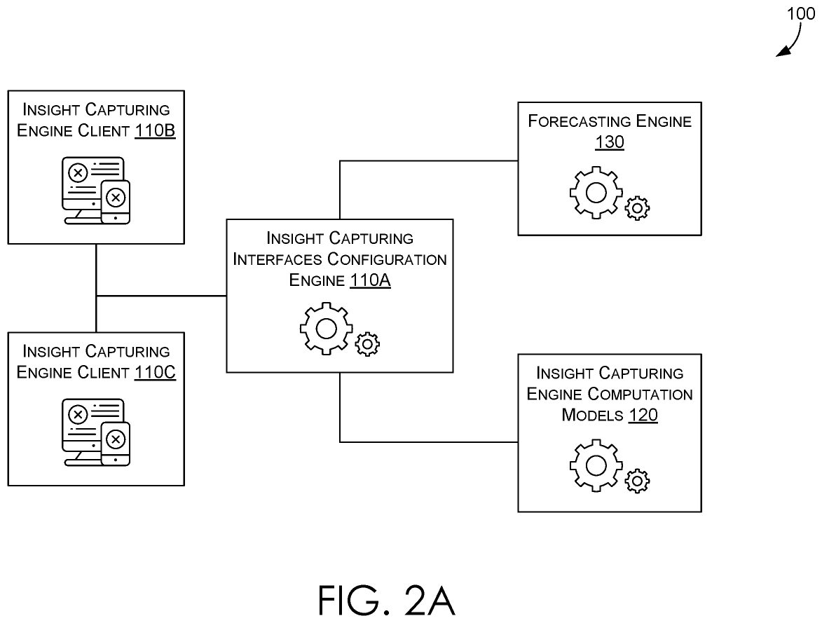

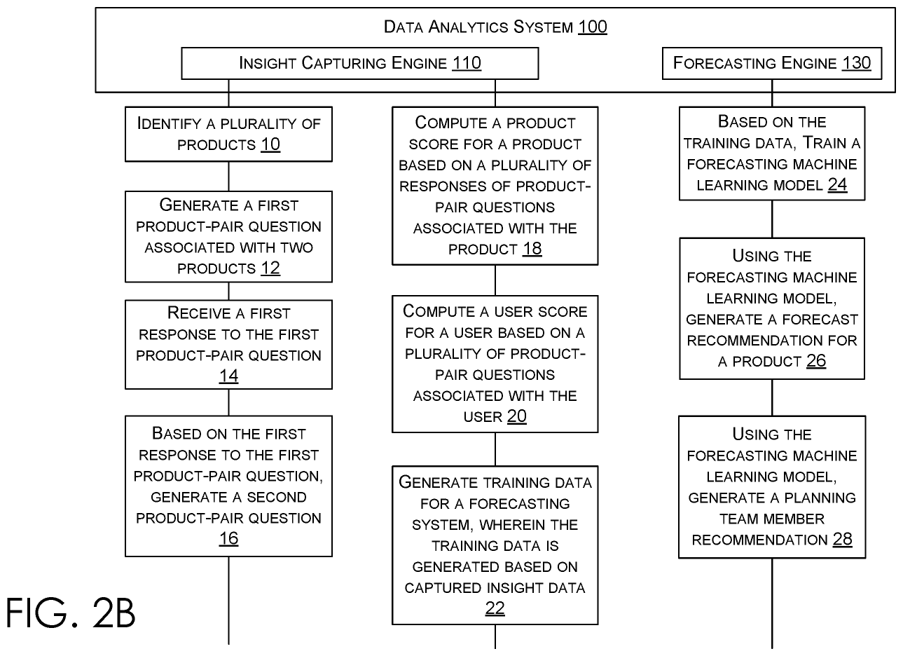

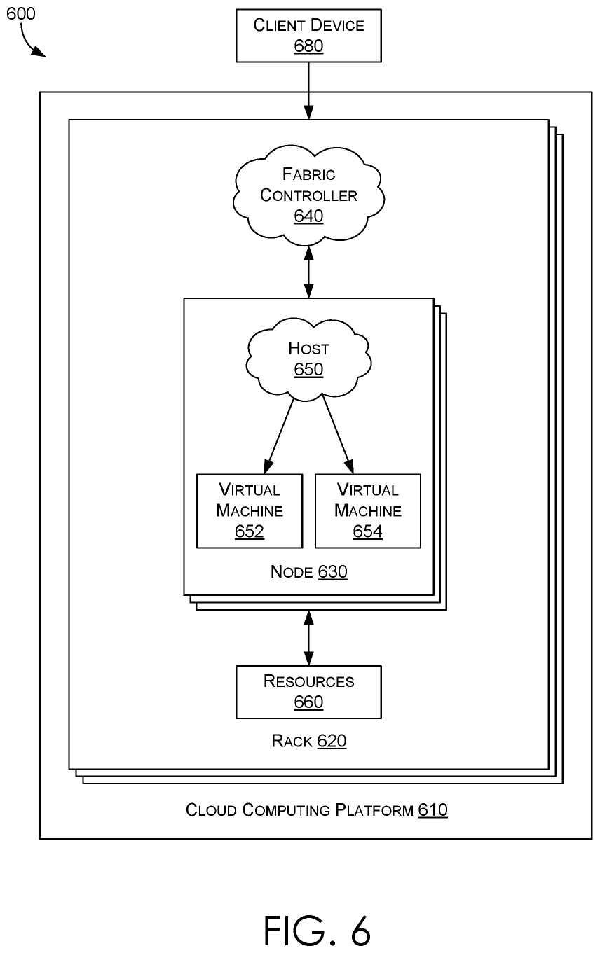

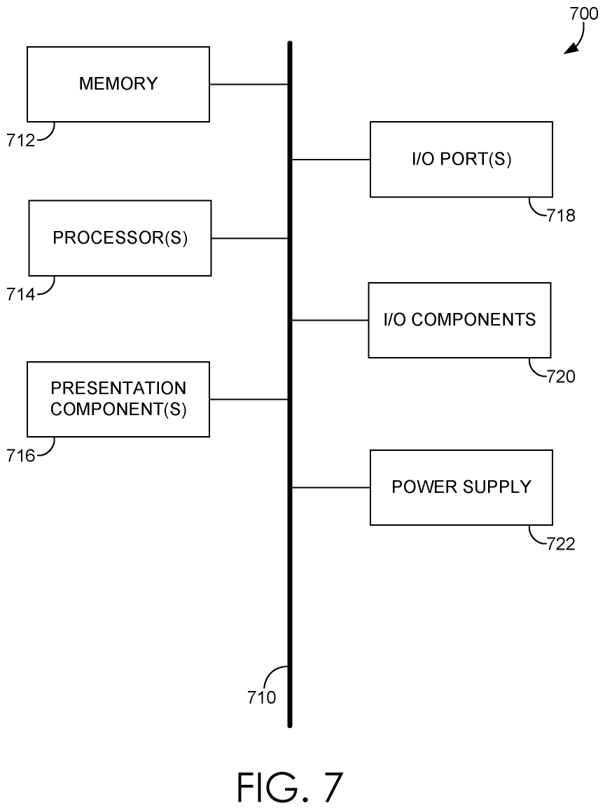

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example data analytics system 100 in which methods of the present disclosure may be employed. In particular, FIG. 2A shows a high level architecture of the data analytics system 100 in accordance with implementations of the present disclosure. Among other engines, managers, generators, selectors, or components not shown (collectively referred to herein as “components”), the technical solution environment of data analytics system 100 corresponds to FIGS. 1A and 1B.

With reference to FIG. 2A, FIG. 2A illustrates data analytics system 100 insight capturing interfaces configuration engine 110A, insight capturing engine client 110B, insight capturing engine client 110C, insight capturing computation models 120 and forecasting engine 130. With reference to FIG. 2B, FIG. 2B illustrates an insight capturing engine 110. At block 10, a plurality of products are identified for performing data analytics. The products can be associated with product features that are tracked for demand forecasting with machine learning techniques that can help forecasting future sales or other product predictions. Demand forecasting can include predicting demand for products such that manufactures can decide what products should be produced.

At block 12, a first product-pair question is generated. The first product-pair question can be identified. The first product-pair question can be a pairwise comparison question that can be generate based on the features (e.g., attributes) of the products being compared and user responses. At block 14, a response to the first product-pair question is received. At block 16, based on the response to the first product-pair question, a second product-pair question is generated. At block 18, a product score for a product is computed. The product score for the product is computed based on the plurality of responses of product-pair questions associated with the product. At block 20, a user score for a use is computed based on the plurality of product-pair questions associated with the user. At block 22, forecasting machine learning training data is generated. The forecasting machine learning training data is generated based on the captured insight data. At block 24, based on the forecasting machine learning training data, a forecasting machine learning training model is generated. At block 26, using the forecasting machine learning training model, a forecast recommendation is generated for a product. At block 26, using the forecasting machine learning model, a planning team member recommendation is generated.

### Exemplary Methods

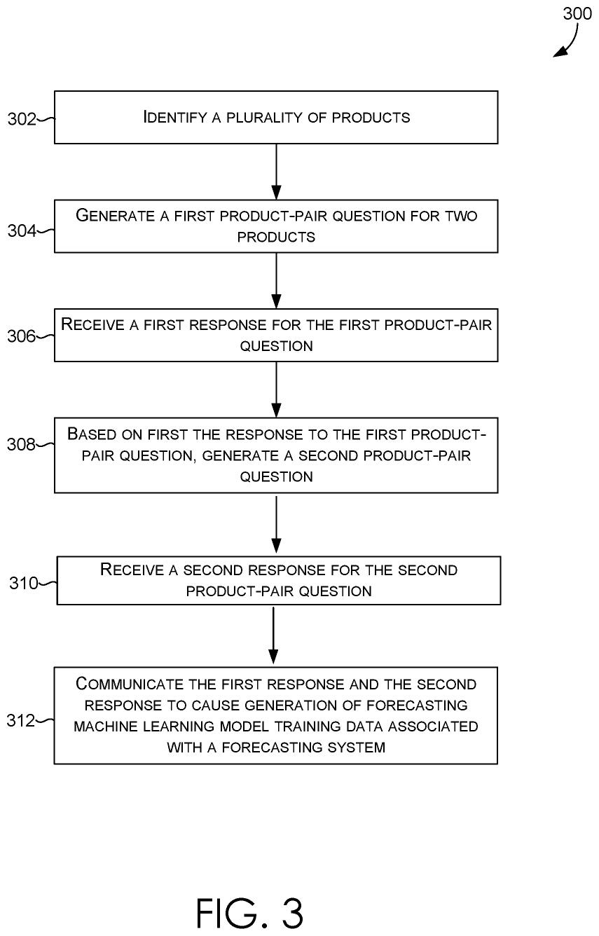

With reference to FIGS. 3, 4 and 5, flow diagrams are provided illustrating methods for providing an insight capturing interface of an insight capturing engine in a data analytics system. The methods may be performed using the data analytics system described herein. In embodiments, one or more computer-storage media having computer-executable or computer-useable instructions embodied thereon that, when executed, by one or more processors can cause the one or more processors to perform the methods (e.g., computer-implemented method) in the data analytics system (e.g., a computerized system or computing system).

Turning to FIG. 3, a flow diagram is provided that illustrates a method 300 for providing insight capturing interface of an insight capturing engine in a data analytics system. At block 302, identify a plurality of products. The plurality of products can be associated with capturing insight data (i.e., captured insight data). For example, an insight capturing engine, can be used to capture captured insight data associated with an insight capturing interface for aggregating the captured insight data comprising responses from a plurality of users, wherein the responses are associated with a product and product-pair questions corresponding to the product. he insight capture interface operates based on a gamification framework comprising game-design interface elements and game principles, wherein the insight capture interface operates based on a swiping user interaction model for providing responses.

At block 304, generate a first product-pair question for two products. At block 306, receive a first response for the first product-pair question. At block 308, based on the response the first product-pair question, generate a second product-pair question. At block 310, receive a second response for the second product-pair question. At block 312, communicate the first response and the second response to cause generation of forecasting machine learning model training data associated with a forecasting system. Forecasting machine learning training data can be generated based on responses of corresponding product-pair questions. For example, a forecasting engine data preparation model processes the captured insight data and extracts or computes features associated with training the forecasting machine learning model, wherein the forecasting engine data preparation model retrieves additional forecasting machine learning model data not associated captured insight data. Forecasting machine learning models are generated using a forecasting engine that support training, validating, and deploying the forecasting machine learning model for product demand planning in a supply chain management process.

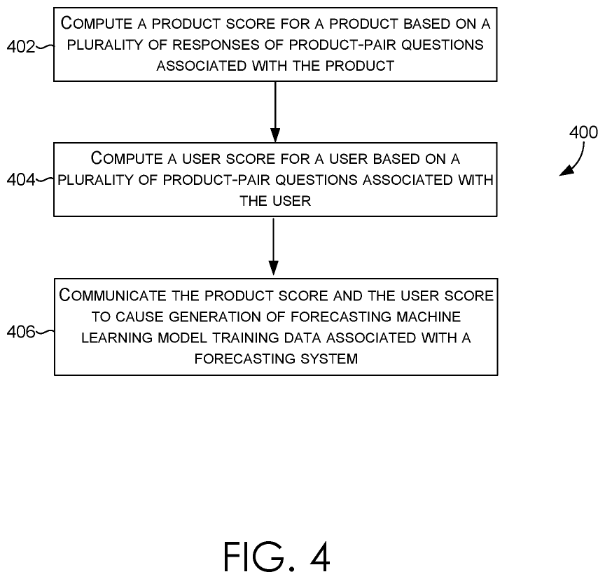

Turning to FIG. 4, a flow diagram is provided that illustrates a method 400 for providing insight capturing interface of an insight capturing engine in a data analytics system. At block 402, compute a product score for a product based on a plurality of responses of product-pair questions associated with the product. At block 404, compute a user score for a user based on a plurality of product-pair questions associated with the user. For example, a scoring computation model can be configured to generate the user scores and the product scores based on the responses received from the plurality of users. User scores generated based on backtesting data associated with the responses, wherein the backtesting data supports updating user scores. An upskill analyzer for performing clustering operations based on the responses to identify latent relationships in the captured insight data. At block 406, communicate the product score and the user score to cause generation of forecasting machine learning model training data associated with a forecasting system.

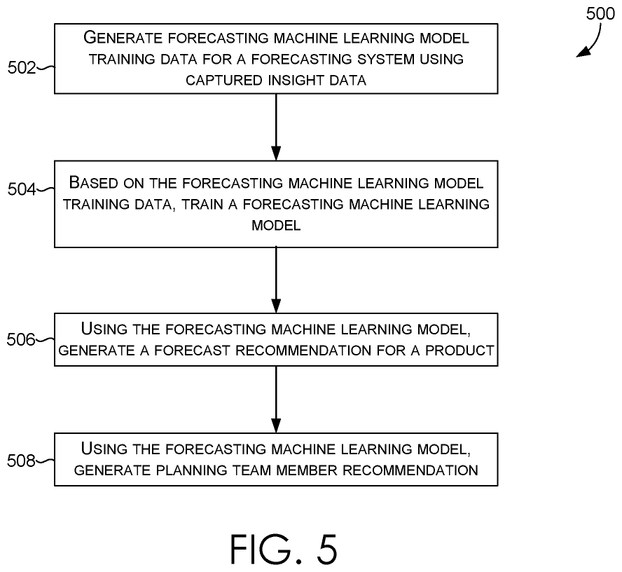

Turning to FIG. 5, a flow diagram is provided that illustrates a method 500 for providing insight capturing interface of an insight capturing engine in a data analytics system. At block 502, generate forecasting machine learning model training data for a forecasting system using captured insight data. At block 504, based on the forecasting machine learning model training data, train a forecasting machine learning model. At block 506, using the forecasting machine learning model, generate a forecast recommendation for a product. At block 508, using the forecasting machine learning model, generate planning team member recommendation. The forecast recommendation for the product and a planning team member recommendation can be present via an insight capturing interface having insight capturing interface elements associated with a product ranking interface, a dashboard interface, a community interface, and forecast interface.

### ADDITIONAL SUPPORT FOR DETAILED DESCRIPTION OF THE INVENTION

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Distributed Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at an insight capturing engine, captured insight data associated with an insight capturing interface for aggregating the captured insight data comprising responses from a plurality of users, wherein the responses are associated with a product and product-pair questions corresponding to the product;
based on the captured insight data, generating forecasting machine learning training data, wherein the forecasting machine learning training data is generated based on responses of corresponding to the product-pair questions;
based on the forecasting machine learning training data, training a forecasting machine learning model, wherein training the forecasting machine learning model comprises evaluating user scores and products scores that are computed based on the responses corresponding to a user; and
using the forecasting machine learning model, generating a forecast recommendation for one or more products.

2. The system of claim 1, wherein the captured insight data is captured based on:
identifying a plurality products;
generating a first product-pair question for two products from the plurality of products;
causing presentation of the first product-pair question;
receiving a first response to the first product-pair question; and
based on the first response to the first product-pair question, generating a second product-pair question;
causing presentation of the second product-pair question to the user; and
receiving a second response to the second product-pair question.

3. The system of claim 1, further comprising a pair identifier configured to identify product pairs for questions based on attributes of products or based on previously received responses from the user.

4. The system of claim 1, further comprising a scoring computation model configured to generate the user scores and the product scores based on the responses received from the plurality of users.

5. The system of claim 1, wherein user scores generated based on backtesting data associated with the responses, wherein the backtesting data supports updating user scores.

6. The system of claim 1, further comprising an upskill analyzer for performing clustering operations based on the responses to identify latent relationships in the captured insight data.

7. The system of claim 1, wherein the insight capture interface operates based on a gamification framework comprising game-design interface elements and game principles, wherein the insight capture interface operates based on a swiping user interaction model for providing responses.

8. The system of claim 1, forecasting engine data preparation model processes the captured insight data and extracts or computes features associated with training the forecasting machine learning model, wherein the forecasting engine data preparation model retrieves additional forecasting machine learning model data not associated captured insight data.

9. The system of claim 1, wherein the forecasting machine learning models are generated using a forecasting engine that support training, validating, and deploying the forecasting machine learning model for product demand planning in a supply chain management process.

10. The system of claim 1, further comprising insight capturing interface elements associated with a product ranking interface, a dashboard interface, a community interface, and forecast interface.

11. The system of claim 1, wherein the insight capturing interface comprises a product ranking interface that supports presenting questions and receiving responses to questions.

12. The system of claim 1, wherein the insight capturing interface comprises a dashboard interface that supports retrieving and presenting key performance indicators associated with the product.

13. The system of claim 1, wherein the insight capturing interface comprises a community interface that supports comparing captured insight data corresponding to the user to captured insight data corresponding to the plurality of users.

14. The system of claim 1, wherein the insight capturing interface comprises a forecast interface that supports presenting a forecast recommendation associated with the product.

15. One or more computer-storage media having computer-executable instructions embodied thereon that, when executed by a computing system having a processor and memory, cause the processor to:
identify a plurality products;
generate a first product-pair question for two products from the plurality of products;
cause presentation of the first product-pair question to a user;
receive a first response to the first product-pair question;
based on the first response to the first product-pair question, generate a second product-pair question;
cause presentation of the second product-pair question;
receive a response to the second product-pair question; and
communicate the first response and the second response to cause generation of forecasting machine learning model training data associated with a forecasting system.

16. The media of claim 15, further comprising insight capturing interface elements associated with a product ranking interface, a dashboard interface, a community interface, and forecast interface.

17. The media of claim 15, further comprising causing the processor to cause presentation of a forecast recommendation or cause presentation of a planning team member recommendation, wherein the forecast recommendation comprises a predicted demand for the one or more products, and wherein the planning team member recommendation comprises an user and a corresponding skill level of the user corresponding to a user score of the user.

18. A computer-implemented method, the method comprising:
using captured insight data, generating forecasting machine learning training data for a forecasting machine learning engine, wherein the training data is generated based on responses corresponding to a plurality of product-pair questions;
based on the training data, training a forecasting machine learning model; and
using the forecasting machine learning model, generating a forecast recommendation for one or more products or generating a planning team member recommendation.

19. The method of claim 18, wherein the generating the forecasting machine learning training data is based on computing user scores and products scores from the captured insight data, wherein the user scores and product scores are used as features in training the forecasting machine learning model.

20. The method of claim 18, wherein the forecast recommendation comprises a predicted demand for the one or more products, and wherein the planning team member recommendation comprises a user and a corresponding skill level of the user corresponding to a user score of the user.
